(19) United States
(12) Patent Application Publication
(10) Pub. No.: US 2014/0229253 A1
(43) Pub. Date: Aug. 14, 2014

(54) System and Method for Promoting Social Interaction and Efficient Information Exchange

(71) Applicant: Robert L. Farrar, JR., Houston, TX (US)

(72) Inventor: Robert L. Farrar, JR., Houston, TX (US)

(21) Appl. No.: 13/763,401

(22) Filed: Feb. 8, 2013

(51) Int. Cl. G06F 17/30

(52) U.S. Cl. CPC G06F 17/30705
USPC 705/14.19; 707/737

(57) ABSTRACT

Personal experiences of users are cataloged into a Library, all aspects of which are specifically tied to a location. Users are linked to other users and to groups of common interest. Personal experiences are searched by users based on content category and locations. Search results are filtered based on content, links between searchers and content creators; and rated for relevance. Commercial content is targeted to users to help identify goods and services of interest based on search results. The resulting social networking system provides credible information and opinions about places in which the user has an interest and reliable data about that interest and targeted advertising opportunities to commercial sponsors.

### BACKGROUND OF THE INVENTION

Business and social opportunities present themselves daily. Making meaningful connections from these opportunities require that we know something about the people and places we encounter, for it is those very same personal connections and their respective personal experiences which ultimately lead to our most credible and trustworthy sources of information.

The proliferation of the World Wide Web (the “Web”) and other aspects of the Internet have resulted in a barrage of people giving their opinions about anything and everything; examples include, but are not limited to: travel, dining, lodging, shopping, and sporting venues. There is no shortage of people who are willing to share their opinions and publish those same opinions online. When the User is not personally acquainted with the source of the information and opinion, the real question becomes whether or not that opinion is truly trustworthy. As an example, the average family may consider a hotel nice due to its large pool, but a seasoned business traveler may realize that the lack of amenities such as a fitness center or free in-room Internet access presents a real drawback. Additionally, a corporate white collar executive may feel that a restaurant is reasonably priced, but a local blue collar family may consider it too expensive.

Opinions are more credible, trustworthy, and influential if the User knows the source of the information behind the opinion. If one knows the source and how the source's profile, lifestyle, and value system compares to their own, then one can more accurately evaluate the opinion in its proper context. For instance, a bad opinion of a hotel by a family may be based upon the fact that no tourist sites of interest are located nearby. Such reasoning may have the opposite effect for a business person trying to avoid distractions while hosting a business conference. Personal experiences, opinions, and information obtained from “known” sources are more credible and reliable and hence, easier to evaluate than those provided by total strangers.

People can be competitive and self-disclosure gives many of us a rewarding feeling of pride and self-worth. Many people like to brag and can spend many hours of each day telling others what they feel or think. We cannot help sharing our thoughts. According to some experts, bragging about personal experiences and expressing opinions assists people in fulfilling the very same sensations as the pleasure that food or money provides.

Many people like to brag about their accomplishments to gain a sense of self-worth. Some people want their accomplishments known to help boost their credibility. Others just want to see how they rank against their fellow man for their own self-satisfaction, or to know that their own values and activities have not strayed from what they would consider normal.

### BRIEF DESCRIPTION OF THE DRAWINGS

FIG. 1 illustrates an Opening Interface for an implementation of a system in accordance with an exemplary embodiment of the invention.

FIG. 2 illustrates a Search Interface for an implementation of a system in accordance with an exemplary embodiment of the invention.

FIG. 3 illustrates an interface for a user profile for an implementation of a system in accordance with an exemplary embodiment of the invention.

FIG. 4 illustrates a personal experience guide interface for a location entry in an implementation of a system in accordance with an exemplary embodiment of the invention.

FIG. 5 illustrates a personal experience guide interface for a tangible object in an implementation of a system in accordance with an exemplary embodiment of the invention.

FIG. 6 shows an interface for a group profile for an implementation of a system in accordance with an exemplary embodiment of the invention.

FIG. 7 illustrates a process by which the library interface contents are determined in accordance with an exemplary embodiment of the invention.

FIG. 8 illustrates a process by which the library interface contents are determined in accordance with an exemplary embodiment of the invention.

FIG. 9 illustrates the process by which volumes are displayed and edited in accordance with an exemplary embodiment of the invention.

FIG. 10 illustrates the process by which volumes are represented within the library interface in accordance with an exemplary embodiment of the invention.

FIG. 11 illustrates the process by which relevance ratings of volumes are determined in accordance with an exemplary embodiment of the invention.

### DETAILED DESCRIPTION OF THE PREFERRED EMBODIMENTS

Described herein is an interactive social networking system (the “System”) which is illustrated through examples of Web type applications. One skilled in the art would appreciate that the innovation may be implemented in various embodiments such as, but not limited to, one or more websites, a single or multi-user computer(s) networking program, and/or a stand-alone application on a dedicated device or a multipurpose computing device platform. Furthermore, the principle can be implemented by the manual processes of indexing and categorizing the material for access directly or indirectly by Users either locally or remotely although accessing and indexing would be cumbersome in such an implementation. The interface could be implemented as a 2-dimensional (“2-D”) or a 3-dimensional (“3-D”) interface, or a simulated 3-D interface in an actual 2-D system, or a physical printed medium.

The primary contents of the System are collections of personal experiences which are detailed responses, descriptions, opinions, ratings, and/or generalized narratives regarding a location, an event, a service, or an activity just to name a few of the many personal experiences that are available for review and evaluation. These contents are referred to as Personal Experience Guides (the “PEGs”). The User's PEGs are categorized and arranged in one or more dynamic subset collections (the “Library”). All Libraries together make up a total collection of all PEGs in the System (the “Global Library”). The Global Library may be implemented as a database with each PEG being records or collections of records within the database. The Libraries are grouped and organized by one or more characteristic similarities of the PEGs contained within. Examples include, but are not limited to: author, subject, location, topic, rating. PEGs are created by Users of the System as a way of creating a personalized profile and content offering (the “Profile”). PEGs are reviewed and information is extracted to enhance the generic profile and categorization of the User thus creating a unique profile.

An account is established by creating an individualized identification (the “User”). Examples may include a User account in a computerized system, or a subscription account to a manual system. In other embodiments, the individualized identification may be associated with existing identifiers such as an email address, a driver's license, or a membership in a club or organization. A plurality of individualized identifications can be linked to create a group or family identification (the “Group”). The Group identification is an amalgamation of the Users' individualized Profiles and is administered by one or more members of the Group.

In one embodiment, PEGs are populated with data by querying a User about their personal experience surrounding a particular event, location, service, etc. Data population can occur by querying the User with a series of multiple choice questions, or free form questions, or by allowing the User to freely narrate regarding their personal experiences. Further, Users may supplement their PEGs by attaching photos, audio, videos, or other experience related content. In one embodiment, the User manually initiates the creation of a PEG. In another embodiment, the creation of a PEG may be initiated in response to a monitored User activity. In one embodiment, a charge to a credit or debit account, or an addition to a rewards club account, or the upload of a media file with certain GPS coordinates may trigger the creation of a PEG.

As an example, a User may book a flight on a specific airline. During or after return travel, the airline may request that the User create a PEG about their personal experience, possibly in exchange for benefit rewards. The airline, knowing the User's account information, and return flight information, may call the User via the seat back phone system found in most planes and ask the User a series of questions which are answered using the touch-tone interface. After completing the questionnaire, the airline may provide a complementary in-flight movie, snack, or beverage. In another example, a User may be provided airport Wireless Internet access during a layover in exchange for creating a PEG regarding the travel experience. In another example, a coffee shop or hotel may offer wireless Internet access in exchange for creation of a PEG about the coffee shop experience, or the hotel accommodations and services.

As an extension of the above example, the airline, upon ascertaining that the travel lasted more than a single day, may prompt the User to fill out a survey about their lodging accommodations and other activities during the visit. Upon ascertaining that the travel corresponds with a particular event, the airline may inquire if the User participated in the event and if so, the User would be asked to create a PEG about such event.

Another such example may be comprised of determining that the User travelled between Green Bay, Wis. and Houston, Tex. and that the Green Bay Packers football team played a game against the Houston Texans in the destination city during the approximate time the traveler was in the city; then querying if the User attended the game, and if so, rewarding the traveler for the submission of a PEG regarding the event. In one embodiment, such a query may be targeted to the User only if it is observed that the User has previously attended similar types of events, or is categorized as having particular interest aligning with the event, such as an observation that the User has attended and recorded experiences for other NFL games, or pro sporting events.

Another example may be determining that the User is traveling to Orlando, Fla. and that the travel party contains one or more younger children, then querying if the User attended one or more of the theme parks for which the city is known, and if so, rewarding the traveler for submission of a PEG(s) regarding their experiences.

As another example, a User may access a dining reservation website, to book a reservation at a restaurant. The website then prompts the User to fill out a survey about their last dining experience in exchange for a reward to be used in connection with future restaurant reservations. In addition, the website may email a survey to the client the day after the reservation and obtain data for a PEG from the returned email response in exchange for rewards.

All PEGs gathered are maintained as a complete collection in the Global Library of the System, which allows Users to view, edit, evaluate, and supplement their own individual or Group PEGs. The Global Library allows one to view, comment, search, rank, and evaluate the PEGs of others, depending on the relation between the person accessing the PEG and the PEG creator or Group members which originated the PEG (the “Relationship”). The information in the PEGs of others may be completely visible, or may be partially visible depending on the Relationship. A User should always be able to manipulate their own PEGs, and depending on their Relationship within a Group, may be able to perform different levels of manipulation on the PEGs of the Group owning a PEG.

Users should be able to view varying amounts of characteristics of the PEGs of other Users to a limited degree, depending on the Relationship. As an example, a User may view and comment on all information on the PEGs of close relationships, but may only view information of more distant relationships without the ability to add comment. Further still, Users may lack a specific relationship with the general public, thus only generic information may be identifiable.

As an example, User A and B have a close relationship, but neither has any affiliation with User C. User A may be able to view User B's PEG reviewing a recent visit to a particular restaurant, and may be able to comment by suggesting that B sample a particular dish on his next visit. User C, while searching for reviews of the particular restaurant may see the PEG of User B reviewing the restaurant, but would not see User A's comment to User B. Further, User C may only see User B, not identified as User B, but only by relevant characteristics, such as identifying User B as “a local,” or as a “fellow member of the ABC group.”

The reviews of friends and family or others known to a User are more relevant than those of strangers. As such, when a User searches for PEGs of a particular characteristic, the PEGs are ranked depending on Relationship. Close relationships' PEGs are displayed before those of friends and acquaintances, and finally PEGs of the public may be displayed.

In the preferred embodiment, a visual interface consists of a globe and a bookshelf presentation. Selection of a specific location on the globe may populate the bookshelf with relevant information available in the System regarding the selected location. Additional categories may offer information relevant to the region surrounding the location. If the System has significant information available on the location, then an “emphasis” zoom may occur to assist the User in refining the search selection. In such an embodiment, PEGs are represented as volumes on a library shelf. Shelves are arranged based on characteristics, and volumes are illustrated based on the various characteristics of PEGs.

As an example, selection of a State on a global map of the Earth may zoom to illustrate multiple cities located in and around that State. Selection of a city may populate the shelves of the library with volumes categorized by transportation, lodging, dining, and events/activities; each subject is represented as a series of volumes on their respective shelves. Volumes may be illustrated as fat “novel-like” books, or small “paperback-like” books, depending on the detail provided by the PEG creator. Larger/taller volumes may represent the PEGs of close Relationships. Shorter volumes may represent the PEGs of those of more distant Relationships. PEGs of Users whom the searcher has identified as highly relevant/respected may be represented as “leather bound tomes.” Those of others may be represented as “glue binding” paper-back books. The use of visual clues regarding the books assists the searcher in quickly identifying specific volumes of PEGs which may be of particular interest or relevance. A User selects one or more volumes to peruse the contents of the PEGs they contain.

One skilled in the art would appreciate that the visual representations of the volumes may be customized by any number of different display characteristics which may correspond to different PEG characteristics and act as visual indications of those characteristics which are different than those described above and still lie within the spirit of the innovation. Further, one skilled in the art would appreciate that the representations may take other forms, such as fruit hanging on a tree whereby the larger more appetizing selections represent more complete PEGs or closer Relationships, and different types of fruits may be grouped on different branches to represent the organization of PEGs by subjects.

In addition to providing highly relevant content in response to a User's search, the System provides a platform for commercial sponsors or advertisers to offer targeted advertisements based on the content of the Global Library and related User searches. Advertisers have attached sponsored ads to search results on the Internet, but this System gives an opportunity to also interpret the PEGs in a User's profile to directly market to individuals for services and items they may need presently or in the future based on their predicted activity.

As an example, when User E searches for information regarding the Italian opera next weekend, Italian themed restaurants in the area may appear as sponsored advertisements for suggested dining options for that evening. With the system described herein, an advertiser may actively seek out Users who may potentially have a need for their services such as Users in the area of the theater who have PEGs for operas or other live fine art entertainment events, or Italian restaurants, or Users who have visited Italy, or otherwise indicated an interest in Italian culture. One skilled in the art would appreciate that this example could be applicable to other influences found in PEGs, which may indicate a potential interest in a commercial sponsor's products or offerings. Studies of human behavior have identified patterns which can be leveraged by advertisers to profile ideal target consumers, and such profiles can be matched with the User Profiles in the Global Library within the System.

In one embodiment, a User accessing and/or updating their personal Profile(s) may receive targeted advertising based on the Profile. This activity generates a cycle whereby updating PEGs from past experiences exposes the User to new opportunities for activities which may be scheduled, organized, or purchased through commercial sponsors of the System and which will later cause the User to update their Profile with PEGs of those opportunities actually experienced.

In the preferred embodiment of the interface, the User's personal experiences and profile relate to specific locations presented on a central map which is a representation of the planet Earth. The User's PEGs are then represented in a volume, or book, on a bookshelf in the Library, and cataloged by subject. In the embodiment, markers (the “Pins”) on the map indicate specific locations of PEGs. Pins may have different colors or some other visual characteristics to indicate PEGs related to the User's Profile, and the Profiles of others. When the User selects a Pin related to their own Profile, the volumes are “re-shelved” so that only those related to the selected Pin are displayed, and the System is placed in an edit mode such that PEGs opened are capable of being edited or supplemented by the User. When the User selects a Pin of another User, the volumes are “re-shelved” so that only those related to the selected Pin are displayed, and the System is placed in a viewing mode. In one embodiment, a User may remove volumes from the shelf and discard them, causing the System to automatically refill the shelf with other volumes which may have not been previously displayed due to their relevance; it being determined to be of lower priority than those which were displayed.

PEGs are personal summaries of facts, impressions, and/or opinions regarding any subject matter prepared by the User and cataloged in the Library. In one embodiment, PEGs include summaries recorded by personal devices. In such an embodiment, the PEGs may include, but are not limited to: audio, video, photos, questionnaires, and narratives regarding the specific subject and experience. In another embodiment PEGs may include, but are not limited to: ratings on standardized scales, answers to standardized questions, answers to sponsor or site created custom questionnaires for the specific experience. For example, a PEG may include narratives about a User's experience with the specific activity. As another example, a PEG may include the User's photos and/or recordings of that activity.

Each User has a collection of PEGs which are individually and personally created, inputted, managed, and enhanced from time to time. Multiple Users may share a group of PEGs in a Group Library. Group Library PEGs may be managed and enhanced by the Group Users working individually or in collaboration. In one embodiment a Group may be a family. In another embodiment, the Group may be travel companions for a specific trip. A group of Users may work together to further enhance the PEGs of other Group members by supplying common pictures, or adding comments to the opinions of the original User/author of a particular PEG.

After entry of new data by a User, the Profile and PEGs of which it is comprised are updated. The Updates are then reflected in the Global Library of the System for other Users to access. For example, if the User has visited a new location, the necessary information regarding the personal experience will be inputted into a PEG which will appear in a volume on the appropriate shelf in the virtual library. The System will identify the location on the map-based interface of Users. The PEG will then be visible to all other Users in the System at some level, depending on the ranking of the PEG among other PEGs available in response to a search of the System. The information within the PEG may be visible to some degree, depending on the Relationship between the User searching and the User authoring the PEG.

The default access of the System, in the preferred embodiment, is a view on the mapping interface of the User's approximate location. The assumption being made that one most likely wants information about their current surroundings. It may be appreciated that cookies, setting files, and preferences may be customized to alter such initial locations. The location thus selected/displayed on the map is utilized by the System to populate the bookshelf interface with volumes which the User has authored. The assumption being that one's own opinions are the most trustworthy. For example, if I liked restaurant X two months ago, I am likely to enjoy restaurant X today, regardless of how others may feel about it. The User may then choose to search the location to expand the selections on the bookshelf interface such that it includes PEGs of other Users. For example, maybe I will not like restaurant X as well as I did two months ago when I see others commenting on the recent change of ownership and chef. The selections on the bookshelf are ranked according to the Relationship with the author of the PEGs since I know and trust those with whom I have a close Relationship over those I do not know. For example, my experience with the restaurant and those of my friends say it is clean and well managed, so I can ignore the PEG describing the “dirty/grimy kitchen conditions” as it was likely written by someone unknown to the User potentially with a grudge against the establishment, and therefore not completely trustworthy.

The User may view all PEGs or selected PEGs based upon personal display preferences. A User may configure their settings to only show PEGs of those with whom a Relationship is established. Such settings can be modified from time to time, or may be temporarily suspended for a single session or search to accommodate the User's current search requirements.

The System may further include PEGs which are not created by an individual User, but are created by specific entities or institutions and are therefore known to be somewhat biased or considered more or less trustworthy based on its origination. As an example; the American Auto Association (AAA) may create PEGs for each member location so that travelers can quickly identify locations where their membership benefits are accepted. As another example; a State tourism board may create PEGs for historical sites and recreation areas or parks to promote tourism to specific locations. As a further example; a hotel chain or restaurant may create PEGs for each of their respective establishments.

In each of the above examples, the PEGs would not have value for their opinions or rankings, as the creators would clearly be biased. Instead, the PEGs would have value for their informational content, as the owners or affiliates of an enterprise should be in possession of the best and most current information about specifics such as, but not limited to: pricing, hours of operation, contact information, services offered. Such PEGs would be identified to differentiate to the User the type of information provided. Examples of differentiation may include, using different color schemes for lettering on the binding of books, or placing gold foil edging on the virtual pages of the book image, or representing the volume in a “newspaper” style when it is opened and viewed.

Another method of distinguishing PEGS when viewed as volumes on a shelf of a virtual bookshelf is the use of colored bindings, or colored binder printing. In an embodiment, volumes which may be edited may have gold writing, volumes of Users sharing Group PEGs may have silver writing, and those of the general public may have black or white writing, while those of commercial origin as described above may have red writing. In another embodiment, the thickness of a volume may indicate how much information is included within, or how complete the volume is determined to be. In another embodiment, the height of volumes or the characteristics of the volume may indicate relevance to the search. For example, volumes represented as taller hardback volumes may be highly relevant to the User's search, whereas volumes represented as paperbacks may have less relevance, and those represented as newspapers, magazines, or pamphlets may be identified as biased content by commercial entities rather than individuals or Groups.

PEGs can be initiated and created by Users on their personal devices either during or after a personal experience and are cataloged into their Library and the Global Library immediately, or may be created during the excursion and finalized upon returning home. Once input to the System the PEGs are automatically cataloged and filed in the Library. In one embodiment, a User may create a PEG manually. In another embodiment, a User may link credit or debit accounts to the System whereby a travel related activity may trigger a prompt by the System for the User to create a PEG. Examples include, but are not limited to: air travel prompts a PEG regarding the carrier; lodging prompts a PEG regarding quality of the accommodations. Restaurant charges may prompt a PEG regarding the quality of the food, the service, ambiance, or location of the restaurant.

A User may select one of his own individual PEGs from the Library to review content regarding a past personal experience or to update a previously filed PEG. Furthermore, the User may also access the PEGs in the Global Library of others in the User's peer network based on their Relationship to review their personal experiences. The User may also review certain information from the PEGs of those outside of the User's peer network, but in the greater universe of Users. Additionally, the User can seek to be included in the network of others to review more private information and their more specific User Profiles.

Examples of personal PEGs that may be input by the User are: Where have you vacationed? Which countries have you visited? Which golf courses have you played? Where have you lived? Worked? Fly fished? Dined? Canoed? Attended Super Bowls? Thereby, the System allows the User to discreetly brag without the risk of offending others in the network.

As PEGs are completed and input in the System, Users may receive rewards furnished by commercial sponsors (the “Rewards”). Rewards are awarded based on the quality and completeness of certain predetermined criteria defined in concert with the commercial sponsors. Although no attempt is made to provide comparisons to Reward totals of other Users, it is easy for the primary User to observe and evaluate his personal experiences, and Rewards associated therewith. These metrics function as unique and primary vectors driving the website and expanding the User's influence within the User's peer network, and within the larger community. Users maintain their respective PEGs and compare personal experiences with family, friends, and business associates; where they have been, what they have done and what they have accomplished.

Rewards represent a point system directly related to the User's PEGs and allow the User to compare his personal experiences against that of other Users in his network, and in the greater community. The more Rewards awarded the User, the more influence exerted by the User within the social network and with the commercial sponsors. As an example; if a User has traveled to twenty-five different countries on three continents and those personal experiences are inputted into PEGs, this data would constitute Rewards on his travel shelf; entitling the User to certain predetermined benefits from commercial sponsors based on the number of Reward points accumulated by the System for the User's account and thereby rewarding the User for his efforts. Sponsors will reward Users for various reasons which are not the subject of this disclosure. In the preferred embodiment the System is called eGoPlaces, and Users are referred to as authors. Rewards earned by the Users are referred to as “Braggin' Rights.”

In one embodiment, the rewards may appear on the interface of the User as virtual trophies, ribbons, or plaques displayed in conjunction with other elements of the virtual interface. In another embodiment, the interwoven theme may be expanded on by having the rewards appear as stamps on a virtual library card or as visa stamps in a virtual passport. In an embodiment, Users may simply view the “trophy case” of their own Profile, or the Profiles of others.

The System simultaneously serves as a diversified, worldwide marketing intermediary whereby a User's PEGs, based upon actual personal experiences, are designed to provide credible and reliable personal information, preferences, and individualized opinions which are utilized to generate relevant and targeted advertisements by commercial sponsors. The advertisements are generated in accordance with predetermined criteria designed for, among other purposes, increasing new business, and expanding the influence of commercial sponsors. The criteria guiding marketing and advertising is based upon present locations, past locations and planned future locations of the PEGs of the Users contained within the Library. During any online session, PEGs may be aligned with advertisements for travel, lodging, dining, shopping, entertainment, sports venues, arts and culture centers, tourism, recreational and hobbies, business and investment interests, primary and secondary residences, and others.

Advertising is generated in accordance with criteria developed in conjunction with the System's commercial sponsors, which filter, mine, sort, and organize the data from all PEGs in the Global Library. The System transfers the PEGs by subject to locations on the System's interactive Map Interface. Advertising, including links to the commercial sponsors, is then directed and appropriately targeted to the User's specific areas of interest. For example, if a User located in Duluth seeks data about planning a wedding in Lake Tahoe, after the User has inputted the relevant request, the System will generate PEGs from other network Users to review along with primary and secondary interactive advertising that will be displayed on the User's search results. With the comprehensive cooperative business environment created by the System, the User will have access to advertiser information that caters to every facet of the wedding in Lake Tahoe, or any other experience cataloged in the Library and desired by the User.

Since a more complete Profile is highly desirable as it increases one's influence over others, and allows for greater Reward opportunities, it is desirable to complete a User's Profile with as much information as possible. In one embodiment, the System will provide consultation services with experienced personnel to assist Users in locating and identifying input to complete their Profile. In one embodiment, a User may allow a consultant to assist in locating and identifying input related to subjects for which the User may need a more accurate history and description. In one embodiment, a consultant may access historical financial data to determine transactions which may indicate past personal experiences. In another embodiment, a consultant may access historical travel data to determine transactions which may indicate an additional experience. In another embodiment, a consultant may search other information sources to assist a User in identifying and collecting information to complete a profile.

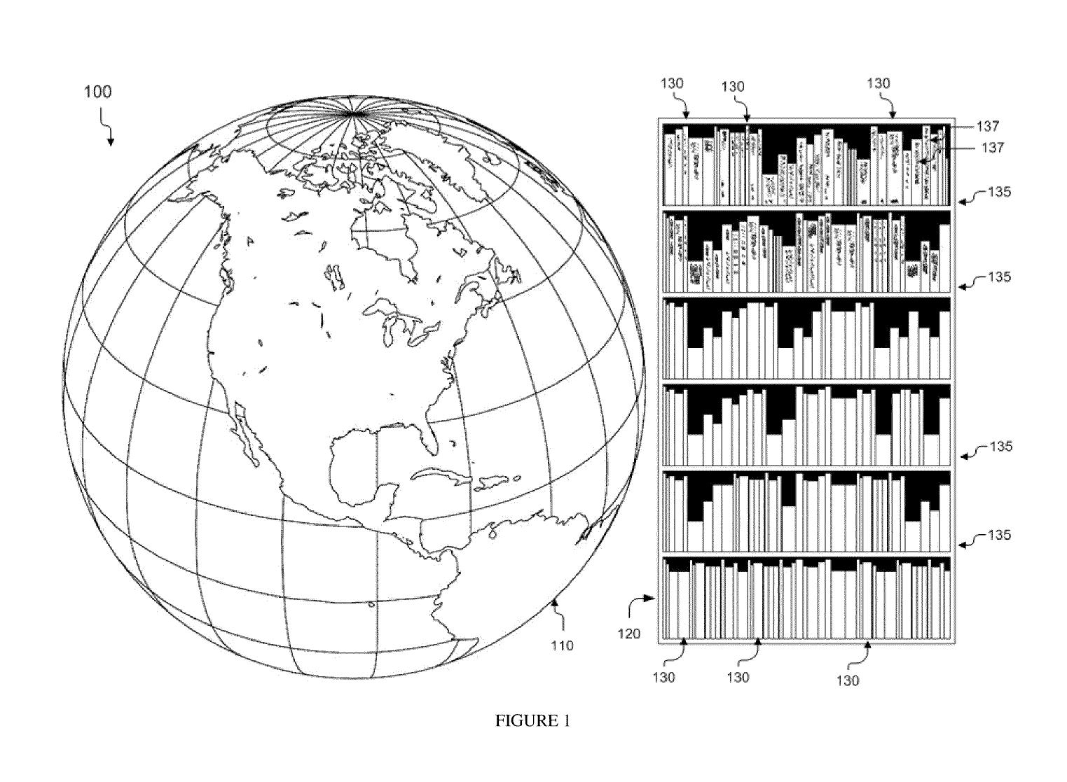

FIG. 1 illustrates an Opening Interface for an implementation of a system in accordance with an exemplary embodiment of the invention. The interface (100) comprises a map interface (110) which may be represented as a three dimensional globe, as illustrated. One skilled in the art would appreciate that the map interface (110) may be represented as a portion of a globe, or as a two dimensional map of limited inclusions, such as, a country, state, regions, area, community, or town. One skilled in the art would also appreciate that any mapping system can be utilized to represent the area encompassed by the System. The interface (100) further comprises a library interface (120) which is represented in the example as a two dimensional bookcase which contains a plurality of personal experience guides (130) also referred to herein as PEGs which may graphically be represented as volumes. The volumes are arranged in categories represented herein by shelves (135) wherein each shelf illustrates a different category. The volumes may include indicators (137) which represent content in a meaningful way to the User. In the representation the indicators are illustrated as titles represented on the “spines” of the volumes. In another embodiment, the indicators may be the names of the authors who created the specific volume (135) entry located in the library (120). In other embodiments, the indicators may represent a relevance rating for the volume or other information which would assist the User in distinguishing the most useful volume.

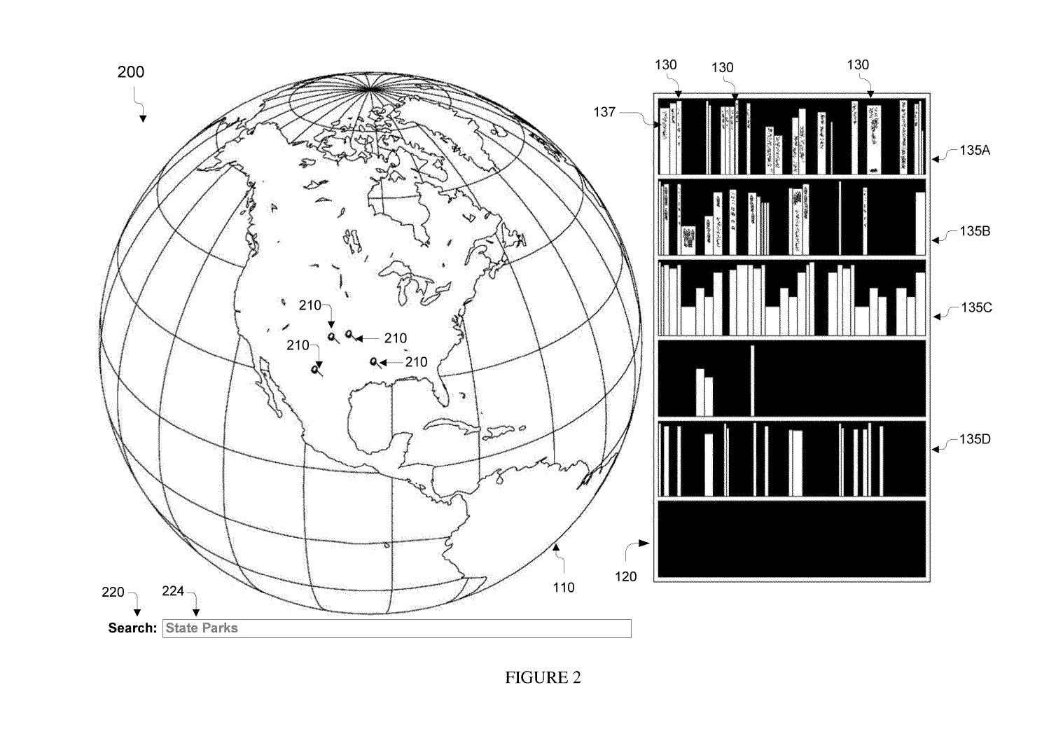

FIG. 2 illustrates a Search Interface for an implementation of a system in accordance with an exemplary embodiment of the invention. The interface (200) comprises a map interface (110) and a library interface (120) as is found in the opening interface (100, not indicated), but additionally a selection dialog (220) is utilized. When the User enters a selection value (224) in the selection dialog (220), one or more location selectors (210) appear on the map interface (110), and the volumes (130) in the library interface (120) are limited to only those relevant to the selection value (224). The volumes (130) are still categorized depending on relevance. In the embodiment illustrated, a first category (135A) may contain volumes (130) authored by the User. A second category (135B) may contain volumes (130) authored by friends and acquaintances. A third category (135C) may contain volumes (130) authored by experts. A forth category (135D) may contain volumes authored by the general community. The volume (130) contains indicators (137) which assist Users in determining the most relevant material. The User may select a volume (130) to view its contents, or may select a location selector (210) to further narrow the displayed selection of volumes (130).

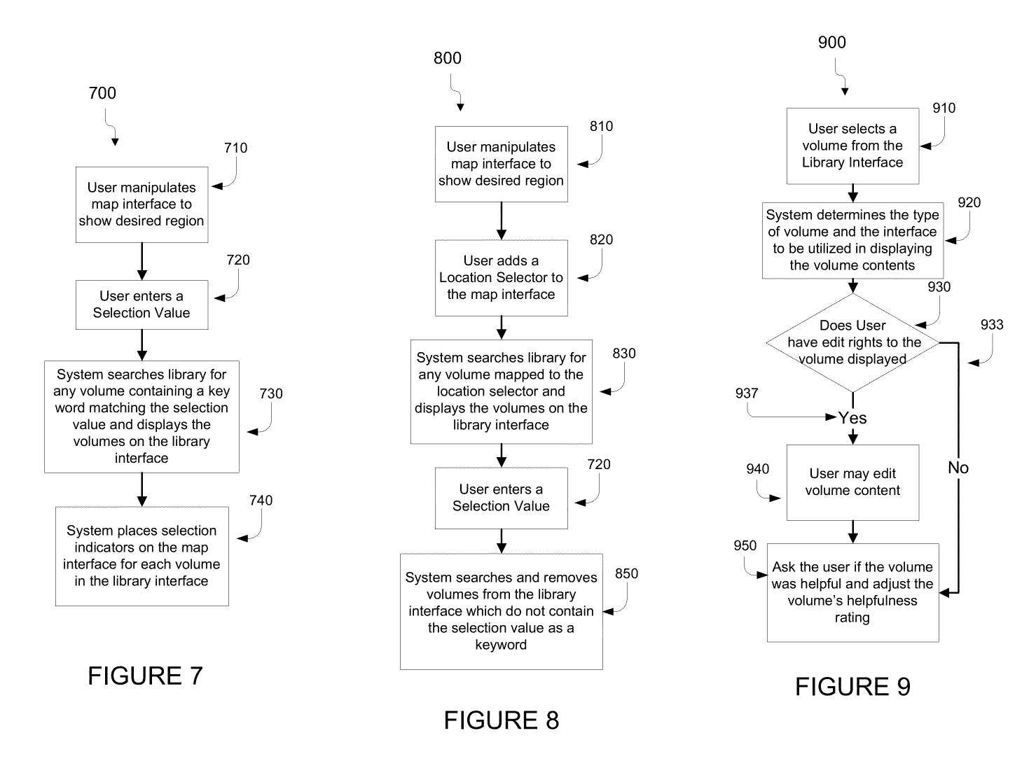

In another embodiment, the map interface (110) is manipulated by the User and location selectors (210) are placed on the map. In response, the selection dialog (220) may indicate key words (224) found in volumes which may then be selected by the User to determine the volumes displayed in the library interface (120). Further reference to possible implementations may be found in discussion of FIGS. 7 and 8 below.

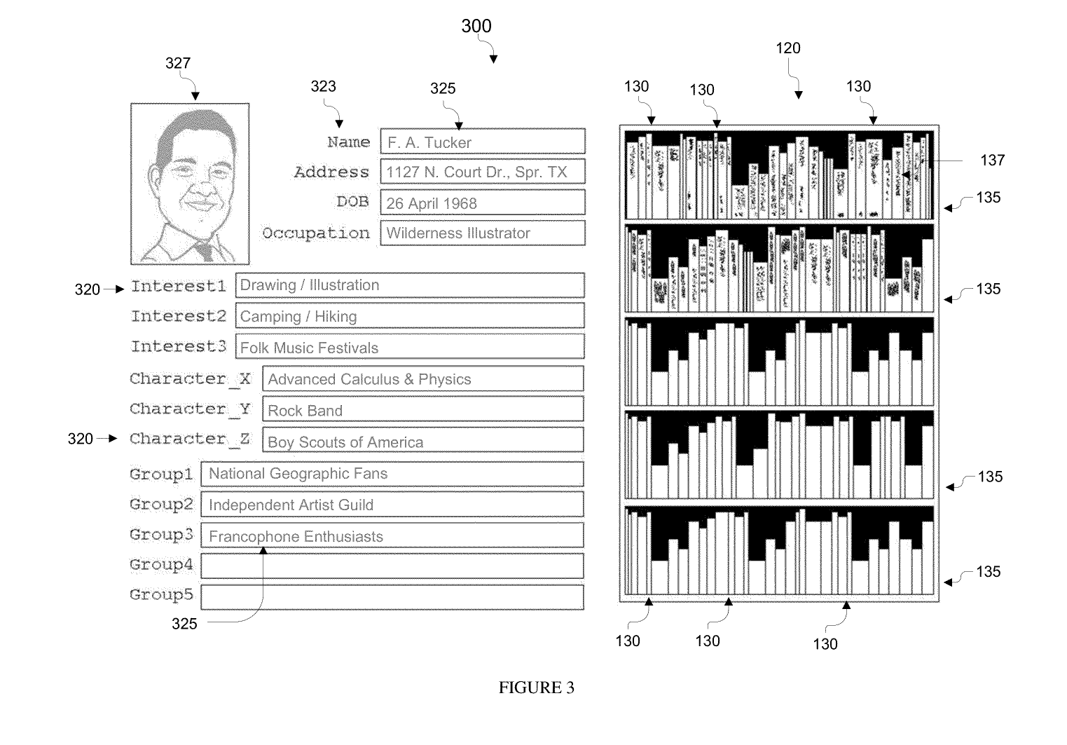

FIG. 3 illustrates an interface for a User profile for an implementation of a system in accordance with an exemplary embodiment of the invention. The profile interface (300) comprises data listed in a plurality of characteristics fields (320), and a library interface (120) showing the volumes (130) authored by the profile owner. Volumes are arranged in categories (135) which are represented in the illustrated implementation as different shelves on a bookcase. Categories may include, but are not limited to: travel locations, lodging, interest, possessions, etc. Indicators (137) allow the User to determine content of the volumes (130) represented in the library interface (120). Characteristics (320) may comprise titles (323) and text data (325), media data (327) and other types of fields as required to best represent the data being stored and collected. Further examples are included below.

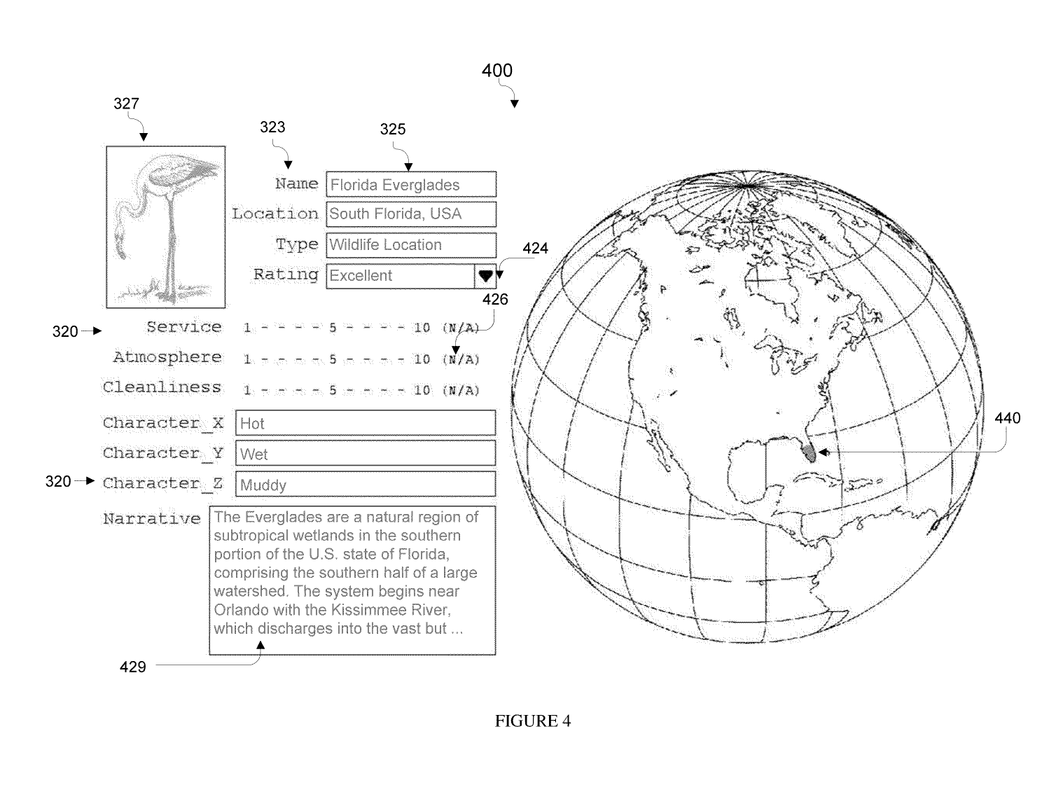

FIG. 4 illustrates a personal experience guide interface for a location entry in an implementation of a system in accordance with an exemplary embodiment of the invention. Personal experience guide interfaces (400) are a representation of content of volumes (130, not shown) which are descriptive of a location. The data's characteristics (320) are represented with field data which may include, but is not limited to: titles (323), text data (325), media data (327), multiple selection data which is active by a dropdown selector (424), or ranking data illustrated by range scales (426). Larger blocks of data may be stored in narrative fields (429). The locations referenced by the PEG (400) may be indicated on the map interface (110, not numbered) by location selectors (210, see FIG. 2) or region markers (440) which represent larger areas rather than specific point locations.

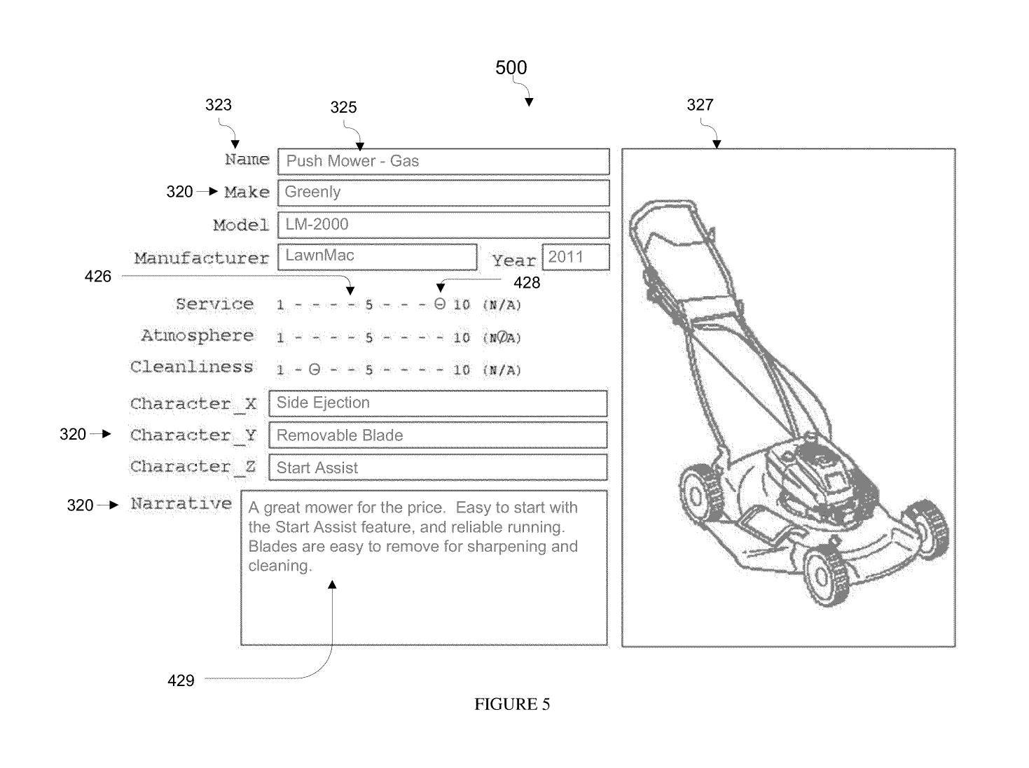

FIG. 5 illustrates a personal experience guide interface for a tangible object in an implementation of a system in accordance with an exemplary embodiment of the invention. Tangible object guide interfaces (500) are representations of content of volumes (130, not shown) which are descriptive of a physically tangible object. Physical objects differ from location in that they are movable objects. As described before, the volume contains characteristics (320) which are indicated by titles (323) and data collected as text data (325), narrative fields (429), media fields (327), or range scales (426) which are marked with range value indicators (428).

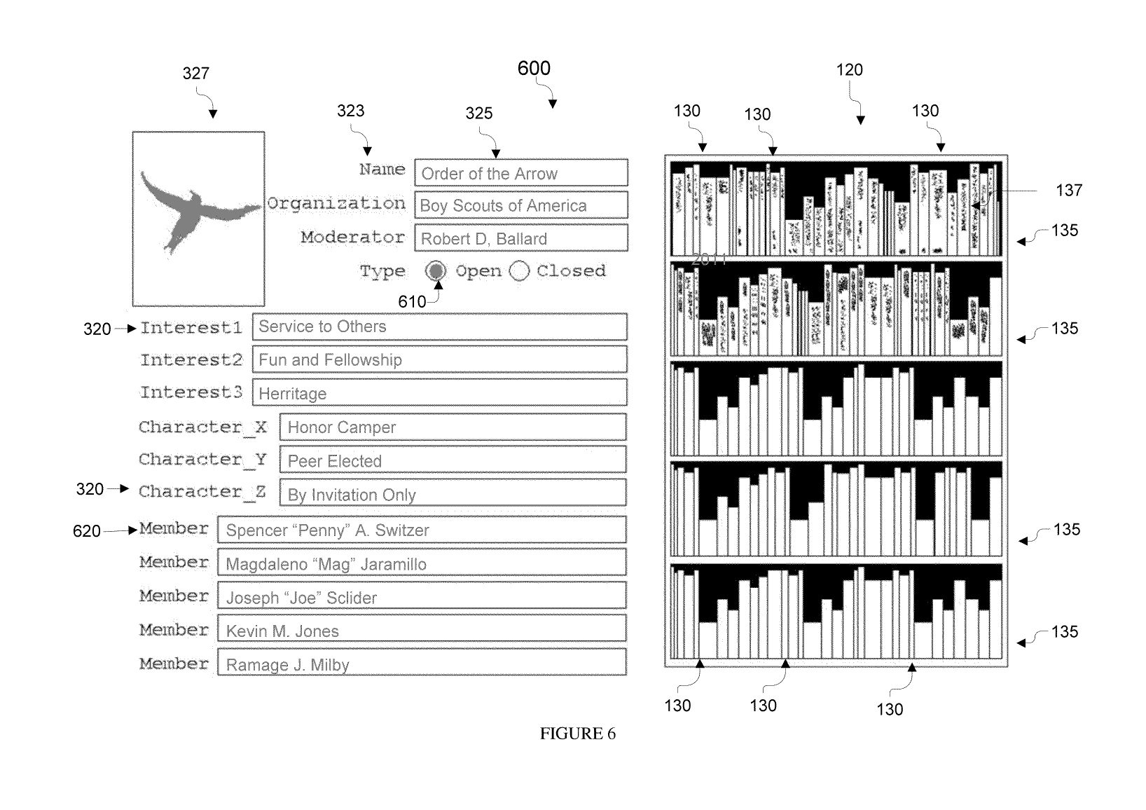

FIG. 6 shows an interface for a group profile for an implementation of a system in accordance with an exemplary embodiment of the invention. In addition to individual profiles (300, see FIG. 3), group profiles (600) represent a collection of individuals which share a common interest or purpose. Illustrated is a group of persons who share common interest, indicated by characteristics (320). In addition to the field titles (323), media data (327), and text data (325), found in previous interface illustrations, some data may comprise a plurality of mutually exclusive values as indicated by the radio button (610). A unique data characteristic (320) in the group profile is a membership list (620) which shows individuals who belong to the group. The library interface (120) may show all volumes (130) of all group members (620), or may be limited to volumes of members which are relevant to the group based on interest, membership, or other common characteristics of the group. Indicators (137) may show the relevance of a volume (130) to the group, and categories (135) may be used to separate multiple interests within the group, or volumes (130) of individual members of the group.

FIG. 7 illustrates a process by which the library interface contents are determined in accordance with an exemplary embodiment of the invention. During the process (700) a User manipulates the map interface to show the desired region (710). This may be accomplished by scrolling, zooming, and otherwise reorienting the representative map. The User enters a selection value (720) in a selection field which consists of keywords which should be contained in relevant volumes. The system searches the library for any volume containing a key word matching the selection value and displays the volumes on the library interface (730). The method of matching the key word to the selection value can be multi-level, in that the system may look for an exact match, then may look for similar matches which may signal less relevance. For instance, if the system looks for an exact match and finds no matches, but finds many matches for a similar term, it may indicate the User has simply misspelled, or miskeyed the selection term. One skilled in the arts would appreciate other methods of achieving relevant content beyond the basic exact match. The system then may place selection indicators on the map interface for each volume matching (740) to aid the User in narrowing the volumes to determine the most relevant to the User's needs. The indicators may have different display characteristics, depending on the relevance of the matching volume.

FIG. 8 illustrates a process by which the library interface contents are determined in accordance with an exemplary embodiment of the invention. During the process (800) a User manipulates the map interface to show the desired region (710). The User then adds one or more location selectors to the map interface (820). The system then searches the library for volumes mapped to the location selector and displays the volumes on the library interface (830). The User may then enter a selection value (720). The system then searches volumes from the sub-library represented on the library interface and removes volumes which do not contain the selection value as a key word. (850). By following this process rather than that indicated in FIG. 7, the system may minimize the resources necessary to search the volumes for a selection key word, as searching for a region would be less resource intensive and would narrow the search field quickly. If the location selection only matches a small number of volumes, then the User may optionally choose not to enter a selection value (720) and simply select a volume from the library interface without further refining the search.

FIG. 9 illustrates the process by which volumes are displayed and edited in accordance with an exemplary embodiment of the invention. The library interface is populated by one of the above processes, or by a different process. This process (900) illustrates how volumes are displayed for User's review. Once the library interface is sufficiently populated with volumes of relevance to the User's needs, volumes of interest may be individually selected by the User (910). The system determines the type of volume and the interface to be utilized in displaying the volume contents in the most relevant manner (920). The system then determines if the User has editing rights to the volume (930). This may be because the User is the author of the volume, or is a member of a group which owns the volume, and allow editing by the members. If the User has editing rights (937) then the interface will allow volume content editing (940). If the User does not have editing rights (933) then the interface will only allow viewing of the content. When a User finishes with a volume, the User is asked if the volume was helpful to the User's needs, and accordingly adjusts the volume's helpfulness rating (950). Other queries may be made of the User and other ratings likewise adjusted. In such a manner the system may further be able to determine relevance of a volume's contents to the original search which yielded the volume. As such, the system may adaptively adjust rankings of relevance.

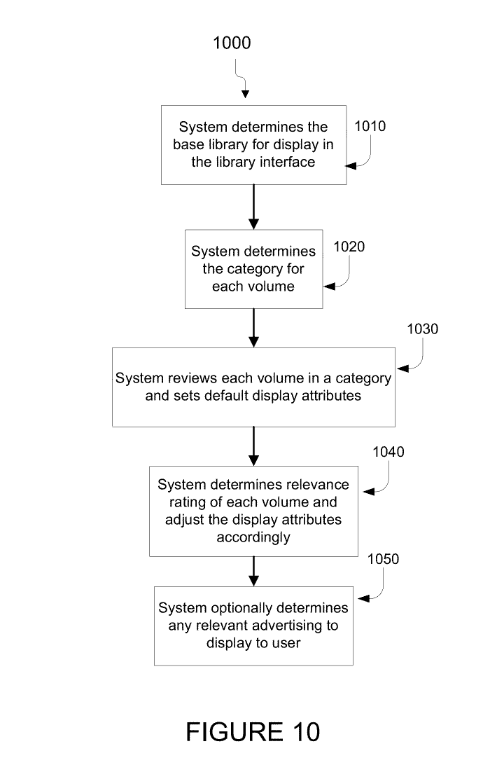

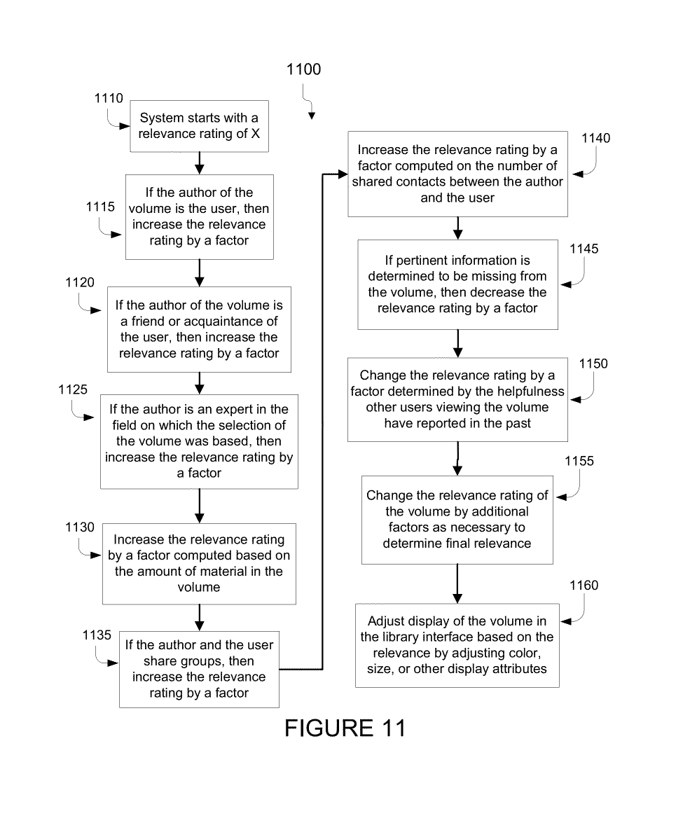

FIG. 10 illustrates the process by which volumes are represented within the library interface in accordance with an exemplary embodiment of the invention. Once the system has selected one or more volumes as potentially relevant to a User's needs (1010), the system must then display them in a fashion which allows the User to easily determine the most relevant volumes. Such a process is illustrated in the flow chart (1000). Each volume is categorized (1020) by relationship of the author to the User, or some other category system. Once each volume is categorized, the system reviews each volume in a category (1030) and sets default display attributes such as size, color, font, and indicators to use in display of the volume in the library interface. The system then determines the relevance rating of each volume (see FIG. 11) and adjusts the display attributes accordingly (1040). In one embodiment, more relevant volumes are displayed in a larger font, or as a wider or taller volume. In other embodiments the colors of the volumes may be adjusted to illustrate their relative relevance ratings. Optionally, the system may determine advertising to display (1050) which may be interspersed with the relevant volumes depending on the User's subscription and/or settings. In one embodiment, advertisements may be color coded to provide access to the User, but allow them to be avoided if not desired. In another embodiment, the User may turn off advertising, or have advertising volumes grouped into a separate category. In other embodiments, the advertising may be hidden among other volumes so that a User is unable to avoid selecting advertising volumes in hopes it will inspire an impulse purchase. In other embodiments, the advertisement may be relevant services to the User's needs.

FIG. 11 illustrates the process by which relevance ratings of volumes are determined in accordance with an exemplary embodiment of the invention. To determine the relevance rating of a volume (1100) the system starts each volume's determination with a default rating (1110) and then adjusts the rating based on a number of factors. If the author of the volume is the User, then the relevance rating is adjusted by a factor (1115). In one embodiment, the factor is determined by the User as part of their system settings. In another embodiment, the factor is determined by the system as part of the adaptive learning based on feedback by the User and/or other users from previous searches.

If the author of the volume is a relation of the User, then the factor may be adjusted (1120). Relation may be determined by reported friendships between parties, similar characteristics of profiles, common groups, and/or other factors. If the author is an expert in the field on which the selection of the volume was based, then the relevance factor is adjusted. Expert status may be determined by the reporting of the author, or others, or it may be determined by the ratings given to other works by the author, or it may be bestowed upon the author by the system based on feedback from Users.

If the author and the User share groups, then the relevance factor may be adjusted (1135). When an author of a volume and a User reviewing that volume have similar interests, then common viewpoints may be inferred, giving more relevance to the materials of such author's works. Similarly, when an author of a volume and a User share common friends and acquaintances, then similar viewpoints may be inferred giving more relevance to the materials of such authors and their created volumes (1140).

If pertinent information is determined to be missing from the volume, then the relevance rating should be decreased (1145), as the usefulness would likely be impacted by the omission. As other Users review a volume and mark it has helpful to them in their search, the relevance rating of such volume may be adjusted for all future searches (1150) as the volume's material has been judged to be of importance.

The material content of the volume may be evaluated and the relevance adjusted based on a corresponding factor (1130). A volume which is complete and includes lengthy descriptions would be more relevant than a sparsely completed volume with simple one word answers, and standard phrases. Other factors can the useful in determining the relevance ratings of volumes (1155). In some embodiments, a User may be able to adjust the factors, or use scripting languages to refine the search criteria or relevance factoring.

Once the relevance ratings of all volumes in a category are determined, the library interface can be adjusted to distinguish such relevancy determinations. For instance, if all volumes are spread across a relevancy scale in a substantially equal division, then a slight color gradient may be the optimal display characteristic. If all ratings fall into one of three distinct levels, then height of the volumes, or thickness, may be the optimal display characteristic to distinguish the differences. If one volume is a statistical outlier falling far above or below the others, then utilizing a gold colored lettering, or a grey lettering to contrast with the standard black lettering on the indicators of other volumes would quickly convey such information to the User.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to Users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for promoting social interaction comprising:
registering users;
said users creating unique experience content;
associating said content with the specific creating user, the creator;
associating said content with a specific location on a map;
categorizing said content; and
storing said content in a global library.

2. A method as described in claim 1 further comprising:
grouping a plurality of users;
said group of users creating unique experience content;
associating said content with a specific location on a map; and
associating said content with the specific creating group;
categorizing said content; and
storing said content in a global library.

3. A method as described in claim 2 further comprising:
having a first user identify a specific location on a map;
selecting content associated with said location; and
rating the relevance of the content.

4. A method as described in claim 3 wherein rating the relevance of the content further comprises:
identifying the completeness of the content;
ranking the relative completeness of a plurality of content; and
evaluating content above a specific threshold as relevant.

5. A method as described in claim 4 wherein the specific threshold is determined by the first user.

6. A method as described in claim 4 wherein the threshold is dependent on a relationship between the first user and the creator of the content.

7. A method as described in claim 4 wherein the threshold is dependent on a groups associated with the first user and the groups associated with the creator of the content.

8. A method as described in claim 3 further comprising:
having the first user identify a category of content; and
selecting content associated with said location and having said category.

9. A method as described in claim 7 further comprising:
identifying relationships between the first user and the content creator of the selected content; and
ranking content based on the relationship.

10. A method as described in claim 7 further comprising:
displaying a content summary for selected content; and
altering the display characteristics of the content summary for differing characteristics of the content.

11. A method as described in claim 7 further comprising:
displaying a content summary for selected content; and
altering the display characteristics of the content summary for differing characteristics of the content.

12. A method as described in claim 10 wherein displaying content summary further comprises:
displaying individual content as volumes on a bookshelf;
having different shelves represent different categories of content;
having different volume thicknesses represent different completeness determinations of the content; and
having different heights of displayed volumes represent different relationships between the first user and the volume's content's creator.

13. A method as described in claim 7 further comprising:
displaying a content summary for selected content; and
altering the display characteristics of the content summary for differing characteristics of the content.

14. A method as described in claim 1 wherein users may edit content which is associated with them as the creator.

15. A method as described in claim 2 wherein users of a group may edit content which is associated with the group as the creator.

16. A method as described in claim 1 wherein the map is a virtual Earth globe;
said globe being manipulated by rotating, tilting, and zooming.

17. A method as described in claim 2 wherein the map is a virtual representation of the universe;
said universe being manipulated by rotating, tilting, and zooming.

18. A method as described in claim 9 further comprising:
commercial sponsors; said commercial sponsors creating content related to their commercial interest, commercial content.

19. A method as described in claim 17 wherein the commercial sponsors grant rewards to users with content related to their commercial interest.

20. A method as described in claim 19 wherein the rewards are dependent on the completeness of the content, or to searches performed by the user.
